(19) United States
(12) Patent Application Publication
(10) Pub. No.: US 2016/0356969 A1
(43) Pub. Date: Dec. 8, 2016

(54) Optical Coupling Device and Optical Coupling Unit

(71) Applicants: ZTE CORPORATION, Shenzhen (CN); SHANGHAI UNIVERSITY, Shanghai (CN)

(72) Inventors: Fufei PANG, Shenzhen (CN); Tingyun WANG, Shanghai (CN); Qian XIA, Shenzhen (CN); Shiqiong CHEN, Shenzhen (CN); Renwu ZHANG, Shenzhen (CN); Xin GU, Shenzhen (CN); Li ZHAO, Shenzhen (CN); Zhe LIU, Shenzhen (CN); Yu WANG, Shenzhen (CN)

(21) Appl. No.: 15/112,336

(22) PCT Filed: Aug. 20, 2014
(86) PCT No.: PCT/CN2014/084811

§ 371 Date: Jul. 18, 2016

(30) Foreign Application Priority Data
Jan. 16, 2014 (CN) 201420027992.2

(51) Int. Cl. G02B 6/42; G02B 6/34

(52) U.S. Cl. CPC G02B 6/4214; G02B 6/34; G02B 6/425; G02B 6/4244; G02B 6/423

(57) ABSTRACT

Provided are an optical coupling device and an optical coupling unit including the optical coupling device. The optical coupling device includes a right-angle reflecting prism (23) and a mobile optical fibre connector (21). A reflecting surface of the right-angle reflecting prism (23) is provided with a curve reflecting surface (24), the curve reflecting surface being used for gathering and reflecting rays propagated by an optical fibre. The mobile optical fibre connector (21) is fixed to the right-angle reflecting prism (23), to make the rays propagated by the optical fibre being incident on the curve reflecting surface (24) of the right-angle reflecting prism (23).

### TECHNICAL FIELD

The present disclosure relates to the field of optical communications, and in particular to an optical coupling device and an optical coupling unit.

### BACKGROUND

As requirements for interconnection bandwidths between printed circuit boards and between chips in the application fields (broadband communication networks, super computers, big data centres and the like) are continuously increased, bottlenecks of an electrical interconnection technology based on a printed circuit board gradually emerge on a transmission rate. Particularly, for medium and short distances (0.3 m to 1 m), electrical interconnection may merely achieve 10 Gbps-rate transmission mostly, and interconnection at a high speed such as 25 Gbps, 40 Gbps and the like has encountered the bottlenecks about the transmission rate. Consequently, the industry proposes that a copper wire used for connecting to form a circuit is replaced with an optical waveguide, and the optical waveguide is integrated on the printed circuit board to achieve optical interconnection between various circuit elements, so as to achieve high-speed data transmission. An optical interconnection method based on an optical waveguide has the advantages of high bandwidth, high density, high transmission speed, low transmission power consumption, low loss, basic avoidance of crosstalk, electromagnetic compatibility and the like. Thus, replacement of an electric printed backboard with an optical printed backboard based on an optical waveguide has become a general trend of high-speed and broadband interconnection development and is a core technology for solving the problem about interconnection bandwidths of the broadband communication networks, the super computers and the big data centres in the future.

In an interconnection optical waveguide system, there exist a great number of optical path transfer links, such as an optical path transfer between an optical source and an optical waveguide, an optical path transfer between an optical fibre and an optical waveguide and an optical path transfer between two optical waveguides. Therein, optical coupling efficiency is a most concerned factor as the magnitude of coupling efficiency will directly affect the insertion loss of an optical interconnection link, thereby causing shortening of an interconnection distance. Thus, an optical coupling related device plays an important role in the interconnection optical waveguide system, and is an important link for determining the performance of the interconnection system.

So far, there are many methods for implementing the optical coupling related device. However, there is not a standard solution for vertically optical coupling of an interconnection optical waveguide.

### SUMMARY

In order to solve the technical problems existing currently, the embodiments of the present disclosure provide an optical coupling device and an optical coupling unit.

An optical coupling device is provided in an embodiment of the present disclosure, including: a right-angle reflecting prism and a mobile optical fibre connector, wherein a reflecting surface of the right-angle reflecting prism is provided with a curve reflecting surface, the curve reflecting surface being used for gathering and reflecting rays propagated by an optical fibre; and the mobile optical fibre connector is fixed to the right-angle reflecting prism, to make the rays propagated by the optical fibre being incident on the curve reflecting surface of the right-angle reflecting prism.

In an example embodiment, the mobile optical fibre connector is provided with an optical fibre coupling tube, and a central position and an interval of the curve reflecting surface are identical to a central position and an interval of the optical fibre coupling tube.

In an example embodiment, a curvature of the curve reflecting surface is designed according to a value of an aperture parameter of the optical fibre coupling tube, to make rays incident on the curve reflecting surface from the optical fibre at a maximum incident angle being gathered by the curve reflecting surface and then reflected in parallel.

In an example embodiment, when a type of the right-angle reflecting prism of the optical coupling device is a single-path reflecting prism, a double-path reflecting prism, a single-row multi-path reflecting prism or a double-row multi-path reflecting prism in sequence, a type of the mobile optical fibre connector used for fixing the right-angle reflecting prism is a single-row mobile optical fibre connector, a double-path mobile optical fibre connector, a single-row multi-path mobile optical fibre connector or a double-row multi-path mobile optical fibre connector in sequence.

In an example embodiment, a diameter and position of a locating guide pin hole of the right-angle reflecting prism correspond to a diameter and position of a locating guide pin hole of the mobile optical fibre connector.

In an example embodiment, the mobile optical fibre connector is connected to the right-angle reflecting prism via a locating guide pin, and the locating guide pin is connected to the locating guide pin hole in the right-angle reflecting prism and the locating guide pin hole in the mobile optical fibre connector respectively; and the right-angle reflecting prism is fixed to a surface of the mobile optical fibre connector via ultraviolet glue, and the ultraviolet glue is applied to a joint between the locating guide pin and the right-angle reflecting prism, and a joint between the locating guide pin and the mobile optical fibre connector; or applied to an area, connected to the mobile optical fibre connector, at an edge of the right-angle reflecting prism.

An optical coupling unit is provided in another embodiment of the present disclosure, including an optical waveguide and the optical coupling device as mentioned above, wherein the optical coupling device is provided being vertically inserted into the optical waveguide, to make rays reflected by the curve reflecting surface on the right-angle reflecting prism in the optical coupling device being incident in the optical waveguide and propagated.

In an example embodiment, the optical coupling device being vertically inserted into the optical waveguide includes: a groove being provided at a position above a planar optical waveguide substrate in the optical waveguide, the right-angle reflecting prism in the optical coupling device being vertically inserted into the groove, and a size of the groove being greater than or equal to a size of the right-angle reflecting prism.

In an example embodiment, when a type of the right-angle reflecting prism in the optical coupling device is a single-path reflecting prism, a double-path reflecting prism, a single-row multi-path reflecting prism or a double-row multi-path reflecting prism in sequence, a type of the optical waveguide is a single-path optical waveguide, a double-path optical waveguide, a single-row multi-path optical waveguide or a double-row multi-path optical waveguide in sequence.

In an example embodiment, a curvature of the curve reflecting surface of the right-angle reflecting prism in the optical coupling device is designed according to a value of an aperture parameter of an optical fibre coupling tube and a value of an aperture parameter of the optical waveguide, to make rays incident on the curve reflecting surface from the optical fibre at a maximum incident angle being gathered by the curve reflecting surface, and an angle of the reflected ray being smaller than an angle corresponding to an value of an aperture of the optical waveguide.

In an optical coupling device and an optical coupling unit provided by embodiments of the present disclosure, a reflecting surface of a right-angle reflecting prism is provided with a curve reflecting surface, and a mobile optical fibre connector in the optical coupling device is fixed to the right-angle reflecting prism, so that the rays propagated by the optical fibre are incident on the curve reflecting surface, thereby gathering and reflecting the rays propagated by the optical fibre. Thus, the loss of optical propagation can be reduced, and the optical coupling efficiency is improved; and moreover, the optical coupling device and the optical coupling unit provided by the embodiments of the present disclosure have simple structures, and manufacturing methods are simple and easy to operate.

### BRIEF DESCRIPTION OF THE DRAWINGS

FIG. 1 is a cross-section view of a right-angle reflecting prism in a related art;

FIG. 2 is a section view of an optical coupling device provided by at least one embodiment of the present disclosure;

FIG. 3 is a cross-section view of a mobile optical fibre connector provided by at least one embodiment of the present disclosure;

FIG. 4 is a three-dimensional structure diagram of a right-angle reflecting prism provided by at least one embodiment of the present disclosure;

FIG. 5 is a three-dimensional structure diagram of a double-path reflecting prism provided by at least one embodiment of the present disclosure;

FIG. 6 is a three-dimensional structure diagram of a single-row multi-path reflecting prism provided by at least one embodiment of the present disclosure;

FIG. 7 is a three-dimensional structure diagram of a multi-row multi-path reflecting prism provided by at least one embodiment of the present disclosure;

FIG. 8 is a flowchart of a method for manufacturing an optical coupling device provided by at least one embodiment of the present disclosure;

FIG. 9 is a section view of an optical coupling unit provided by at least one embodiment of the present disclosure; and

FIG. 10 is a flowchart of a method for manufacturing an optical coupling unit provided by at least one embodiment of the present disclosure.

### DETAILED DESCRIPTION OF THE EMBODIMENTS

In at least one embodiment of the present disclosure, an optical coupling device including a mobile optical fibre connector and a right-angle reflecting prism is provided. A reflecting surface of the right-angle reflecting prism is provided with a curve reflecting surface, and the mobile optical fibre connector is fixed to the right-angle reflecting prism, so that rays propagated by an optical fibre are incident on the curve reflecting surface, thereby gathering and reflecting the rays propagated by the optical fibre. Thus, the loss of optical propagation can be reduced, and the optical coupling efficiency can be improved.

The present disclosure is further described below with reference to the drawings and specific embodiments in detail.

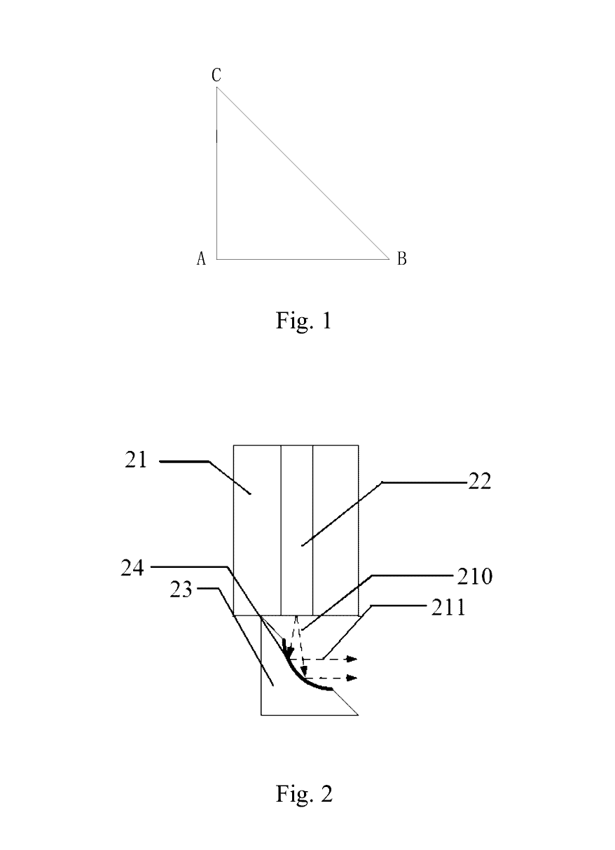

FIG. 1 is a cross-section view of a right-angle reflecting prism. In FIG. 1, two right-angle sides AB and AC represent two side surfaces, vertical to each other, on the right-angle reflecting prism, and BC represents a reflecting surface on the right-angle reflecting prism.

According to at least one embodiment of the present disclosure, an optical coupling device is provided. FIG. 2 is a section view of an optical coupling device according to an embodiment of the present disclosure. As shown in FIG. 2, the optical coupling device includes a mobile optical fibre connector 21 and a right-angle reflecting prism 23. A reflecting surface of the right-angle reflecting prism 23 is provided with a curve reflecting surface 24, and the curve reflecting surface 24 is configured to gather and reflect the rays incident on the curve reflecting surface 24; the mobile optical fibre connector 21 is fixed to the right-angle reflecting prism 23; and the mobile optical fibre connector 21 includes an optical fibre coupling tube 22, and the optical fibre coupling tube 22 is configured to fix and align an optical fibre, so that the rays propagated by the optical fibre are incident on the curve reflecting surface 24 of the right-angle reflecting prism 23.

In an example embodiment, the curve reflecting surface 24 is coated with a high-reflectivity optical thin film, the optical thin film on the curve reflecting surface 24 may be a gold thin film, a silver thin film or other metal thin films, or may be other medium thin films; the film-coated curve reflecting surface 24 can achieve higher reflectivity, thereby totally reflecting incident rays; and when the optical fibre is fixed inside the optical fibre coupling tube 22 in the mobile optical fibre connector 21, the incident rays transmitted by the optical fibre are incident on the curve reflecting surface 24 of the right-angle reflecting prism, and then the incident rays are reflected by the curve reflecting surface 24 coated with the high-reflectivity optical thin film.

In at least one embodiment of the present disclosure, the type and structure of the mobile optical fibre connector 21 are not specially required, and the type of the mobile optical fibre connector 21 includes (but not limited to): Mechanical Transfer Registered Jack (MT-RJ) or Multi-fibre Push On (MPO), which makes the optical coupling device provided by the embodiment of the present disclosure simple in structure and easy to implement.

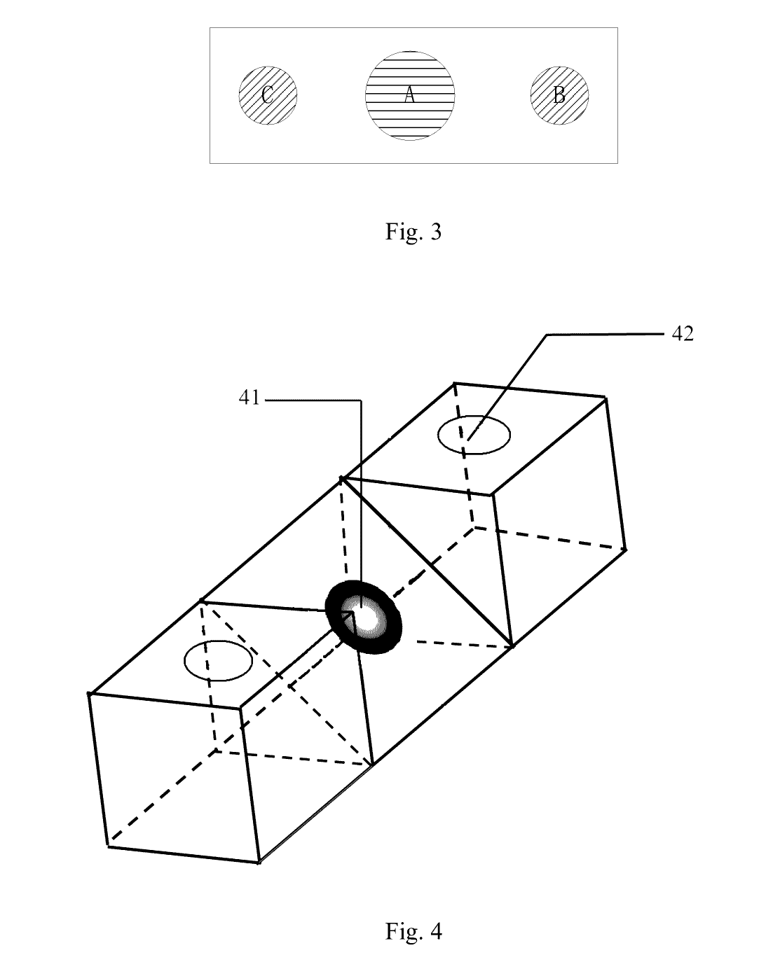

FIG. 3 is a cross-section view of a mobile optical fibre connector 21. A part A filled with transverse lines is a cross section of the optical fibre coupling tube 22, and part B and part C filled with oblique lines show two locating guide pin holes. FIG. 4 is a three-dimensional structure diagram of a right-angle reflecting prism 23 provided by at least one embodiment of the present disclosure. A mark 41 marks a position of the curve reflecting surface, and a mark 42 marks a position of a locating guide pin hole. In practical application, the number and positions of locating guide pin holes in the mobile optical fibre connector 21 and the right-angle reflecting prism 23 may be designed as required, and not limited to the structure provided by the embodiment of the present disclosure.

In practical application, a central position and interval of the curve reflecting surface 24 of the right-angle reflecting prism 23 is identical to a central position and interval of the optical fibre coupling tube 22 in the selected mobile optical fibre connector 21.

The diameter and position of the locating guide pin hole in the right-angle reflecting prism 23 is matched with the diameter and position of the locating guide pin hole in the selected mobile optical fibre connector 21, thereby better connecting the mobile optical fibre connector 21 to the right-angle reflecting prism 23 via the locating guide pin.

As shown in FIG. 2, the right-angle reflecting prism 23 is fixed to the surface of the mobile optical fibre connector 21, so that the rays transmitted by the optical fibre are exactly incident on the curve reflecting surface 24 of the right-angle reflecting prism 23 and are reflected by the curve reflecting surface 24.

In an example embodiment, the mobile optical fibre connector 21 being fixed to the right-angle reflecting prism 23 includes that: the right-angle reflecting prism 23 is connected to the mobile optical fibre connector 21 via the locating guide pin, the locating guide pin being connected to the locating guide pin holes in the right-angle reflecting prism 23 and the mobile optical fibre connector 21 respectively; and in addition, the right-angle reflecting prism 23 is fixed to the surface of the mobile optical fibre connector 21 via a ultraviolet glue, and the ultraviolet glue can be applied to a joint between the locating guide pin and the right-angle reflecting prism 23 and a joint between the locating guide pin and the mobile optical fibre connector 21; or can be applied to an area, connected to the mobile optical fibre connector 21, at an edge of the right-angle reflecting prism 23.

In practical application, a curvature of the curve reflecting surface 24 of the right-angle reflecting prism 23 can be designed according to a value of an aperture parameter of the optical fibre, and the curve reflecting surface 24 has a gathering function for light beams according to a principle of optical reflection. Thus, the curvature of the curve reflecting surface 24 of the right-angle reflecting prism 23 is designed to ensure that the rays incident to the right-angle reflecting prism 23 from the optical fibre at a maximum angle can be gathered by the curve reflecting surface 24 and then reflected in parallel; and the surface type of the reflecting surface optionally includes (but not limited to): a circular arc surface, a paraboloid and the like.

As shown in FIG. 2, after incident rays 210 transmitted by the optical fibre are totally reflected by the curve reflecting surface 24 of the right-angle reflecting prism, parallel reflected light 211 will be obtained due to the gathering function. Thus, an optical loss caused by the divergence of rays when a common reflecting prism is used can be reduced, thereby improving the optical coupling efficiency.

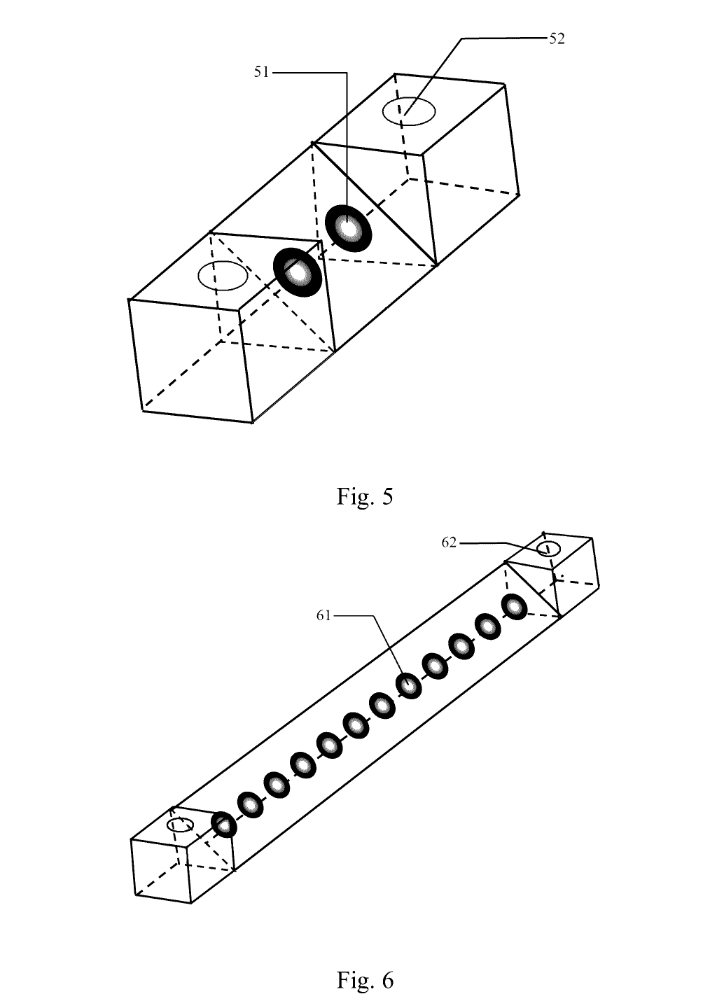

In at least one embodiment of the present disclosure, the right-angle reflecting prism may be a double-path reflecting prism. That is, the reflecting surface of the right-angle reflecting prism is provided with two curve reflecting surfaces. As shown in FIG. 5, mark 52 marks a locating guide pin hole, and mark 51 marks a curve reflecting surface. Correspondingly, the mobile optical fibre connector fixed to the double-path reflecting prism is a double-channel mobile optical fibre connector. That is, the mobile optical fibre connector is a mobile optical fibre connector including two optical fibre coupling tubes. Thus, two paths of rays can be reflected simultaneously.

In at least one embodiment of the present disclosure, the right-angle reflecting prism may be a single-row multi-path reflecting prism. That is, a plurality of curve reflecting surfaces in a single row are provided on an oblique surface of the prism. As shown in FIG. 6, mark 62 marks a locating guide pin hole, and mark 61 marks a curve reflecting surface. Correspondingly, the mobile optical fibre connector fixed to the single-row multi-path reflecting prism is a single-row multi-path mobile optical fibre connector. That is, the mobile optical fibre connector is a mobile optical fibre connector including a plurality of optical fibre coupling tubes in a row. Thus, multiple paths of rays in a single row can be reflected simultaneously.

In at least one embodiment of the present disclosure, the right-angle reflecting prism may be a multi-row multi-path reflecting prism. That is, a plurality of rows of curve reflecting surfaces are provided on the oblique surface of the prism. Each row includes a plurality of curve reflecting surfaces. As shown in FIG. 7, a mark 72 marks a locating guide pin hole, and a mark 71 marks a curve reflecting surface. The mobile optical fibre connector fixed to the multi-row multi-path reflecting prism is a multi-row multi-path mobile optical fibre connector. That is, the mobile optical fibre connector is a mobile optical fibre connector including a plurality of rows of optical fibre coupling tubes, each row including a plurality of optical fibre coupling tubes. Thus, multiple rows and multiple paths of rays can be reflected simultaneously.

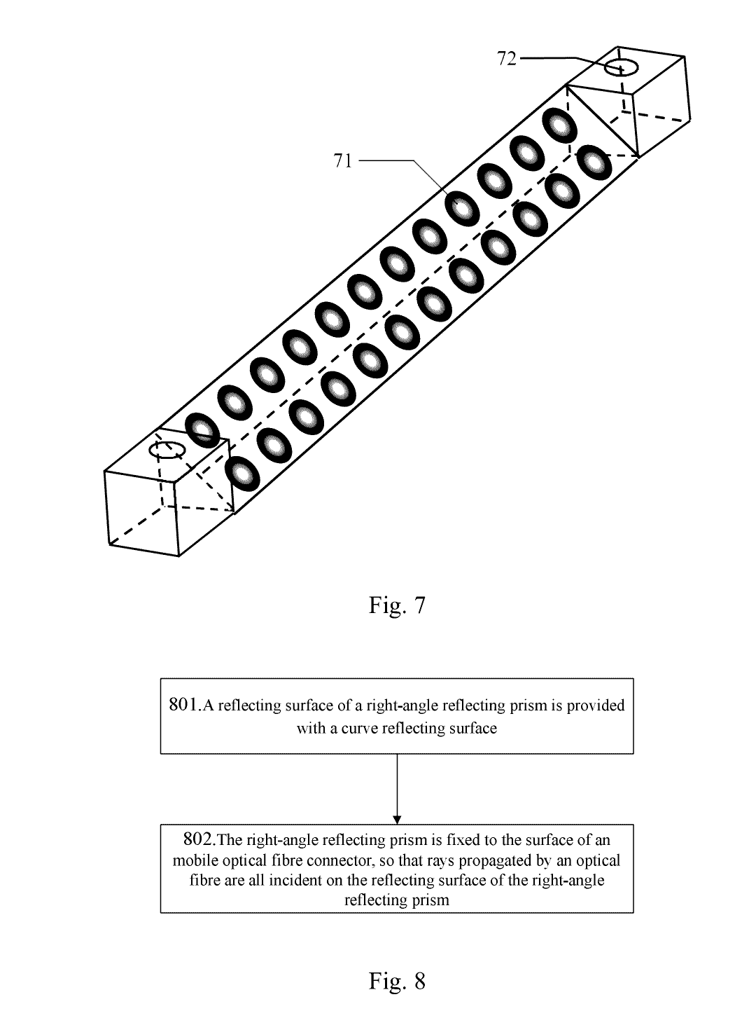

According to at least one embodiment of the present disclosure, a method for manufacturing an optical coupling device is provided. FIG. 8 shows a flowchart of the manufacturing method, and the manufacturing method includes the steps as follows.

Step 801: A reflecting surface of a right-angle reflecting prism is provided with a curve reflecting surface.

Here, the right-angle reflecting prism may be made by adopting an optical polishing technology, a central position and interval of the right-angle reflecting prism is identical to a central position and interval of an optical fibre coupling tube in an mobile optical fibre connector to be fixed to the right-angle reflecting prism; and a diameter and position of a locating guide pin hole in the right-angle reflecting prism is matched with a diameter and position of a locating guide pin hole in the mobile optical fibre connector to be fixed to the right-angle reflecting prism, thereby better connecting the mobile optical fibre connector to the right-angle reflecting prism via a locating guide pin.

In an example embodiment, a central position and interval of the provided curve reflecting surface are identical to a central position and interval of the optical fibre coupling tube in the mobile optical fibre connector to be fixed to the right-angle reflecting prism. A curvature of the curve reflecting surface may be designed according to a value of an aperture parameter of an optical fibre, and the curve reflecting surface has a gathering function for light beams according to a principle of optical reflection. Thus, the curvature of the curve reflecting surface of the right-angle reflecting prism is necessary to be designed to ensure that rays incident to the curve reflecting surface from the optical fibre at a maximum angle is gathered by the curve reflecting surface and then reflected in parallel; and a surface type of the reflecting surface optionally includes (but not limited to): a circular arc surface, a paraboloid and the like. According to a designed curve structure, the reflecting surface is processed on the right-angle reflecting prism by using an ultraviolet laser ablation process, a carbon dioxide laser hot-melting process, a mechanical grinding process or an ultrasonic grinding process.

Wherein, the curve reflecting surface may be coated with a film in a vacuum manner to obtain a total reflection curve surface; and specifically, the coated film may be a gold thin film, a silver thin film or other metal thin films, or may be other medium thin films.

Step 802: The right-angle reflecting prism is fixed to the surface of the mobile optical fibre connector, so that rays propagated by the optical fibre are all exactly incident on the curve reflecting surface of the right-angle reflecting prism.

In an example embodiment, locating guide pin holes in the right-angle reflecting prism manufactured in Step 801 and the mobile optical fibre connector are connected via a locating guide pin. In addition, the right-angle reflecting prism is fixed to the surface of the mobile optical fibre connector via a ultraviolet glue; and specifically, the ultraviolet glue may be applied to a joint between the locating guide pin and the right-angle reflecting prism and a joint between the locating guide pin and the mobile optical fibre connector; or can be applied to an area, connected to the mobile optical fibre connector, at an edge of the prism.

It is important to note that the sequence numbers of the above steps are merely intended to distinguish different steps and do not limit the sequence of the steps. When all steps are executed, there is not a strict sequence.

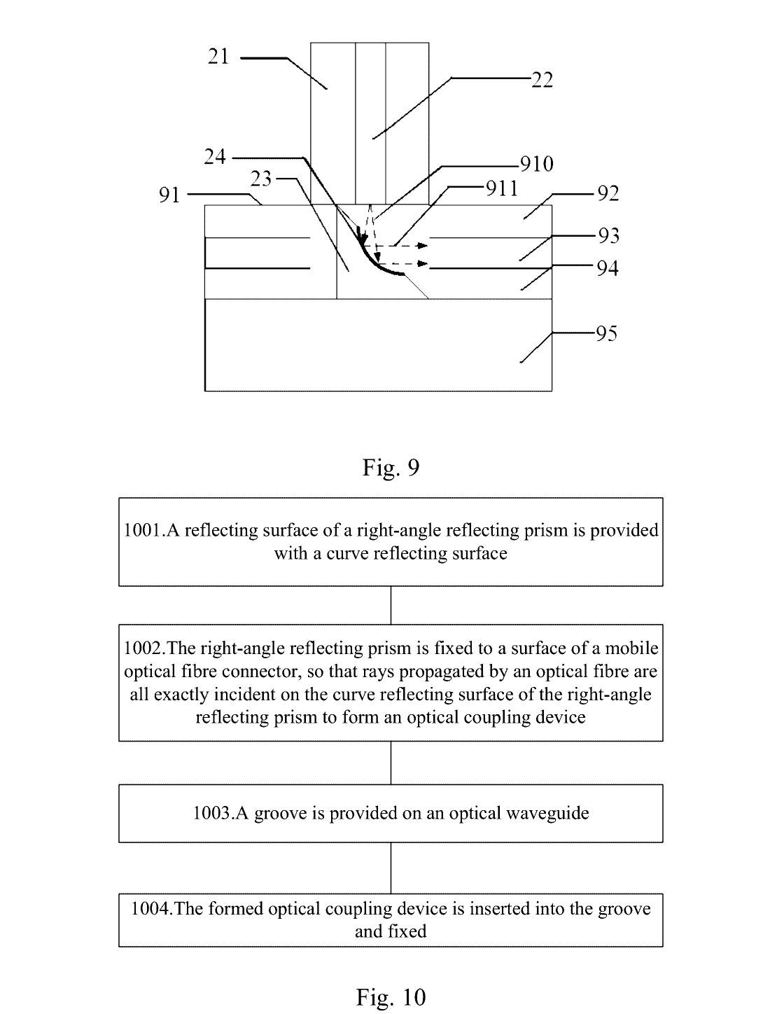

According to at least one embodiment of the present disclosure, an optical coupling unit is provided. As shown in FIG. 9, the optical coupling unit includes the optical coupling device and an optical waveguide 91. The optical coupling device is vertically inserted into the optical waveguide 91, so that rays reflected by a curve reflecting surface in the optical coupling device are incident into the optical waveguide 91 and propagated.

As shown in FIG. 9, the optical waveguide 91 includes a planar optical waveguide substrate 95, a lower optical waveguide cladding material 94, an optical waveguide core material 93 and an upper optical waveguide cladding material 92. The optical coupling device being vertically inserted into the optical waveguide 91 refers to that: a groove is provided at a position above the planar optical waveguide substrate 95 in the optical waveguide 91, so that the right-angle reflecting prism 23 in the optical coupling device is vertically inserted into the groove. The size of the groove is required to be greater than the size of the right-angle reflecting prism. That is, the entire right-angle reflecting prism 23 can be put into the groove.

In an example embodiment, the length of the optical waveguide may be selected according to actual circuit requirements. The type of the optical waveguide may be selected according to the type of the right-angle reflecting prism in the optical coupling device. Specifically, when the right-angle reflecting prism is a double-path reflecting prism, the optical waveguide is selected as a double-path optical waveguide. Thus, when the optical coupling device is vertically inserted into the optical waveguide, a two-path optical fibre and a two-path optical waveguide may be aligned, thereby achieving vertical optical coupling of a double-channel optical fibre and the optical waveguide. When the right-angle reflecting prism is a single-row multi-path reflecting prism, the optical waveguide is selected as a single-row multi-path optical waveguide. Thus, when the optical coupling device is vertically inserted into the optical waveguide, a single-row multi-path optical fibre and a single-row multi-path optical waveguide may be aligned, thereby achieving vertical optical coupling of the single-row multi-path optical fibre and the optical waveguide. When the right-angle reflecting prism is a double-row multi-path reflecting prism, the optical waveguide is selected as a double-row multi-path optical waveguide. Thus, when the optical coupling device is vertically inserted into the optical waveguide, a double-row multi-path optical fibre and a double-row multi-path optical waveguide may be aligned, thereby achieving vertical optical coupling of the double-row multi-path optical fibre and the optical waveguide.

In an example embodiment, a curvature of the curve reflecting surface 24 of the right-angle reflecting prism 23 in the optical coupling device may be designed according to a value of an aperture parameter of the optical fibre and a value of an aperture parameter of the optical waveguide, and the curve surface has a gathering function for light beams according to a principle of optical reflection. Thus, the curvature of the reflecting surface 24 of the right-angle reflecting prism 23 is necessary to be designed to ensure that after the rays incident to the curve reflecting surface 24 from the optical fibre at a maximum angle is gathered by the curve reflecting surface 24, an angle of reflected ray is smaller than an angle corresponding to the value of an aperture parameter of the optical waveguide, that is, there is no loss of light energy. The surface type of the curve reflecting surface optionally includes, but not limited to, a circular arc surface, a paraboloid and the like.

As shown in FIG. 9, in the optical coupling unit provided according to at least one embodiment of the present disclosure, after incident rays 910 transmitted by the optical fibre are totally reflected by the curve reflecting surface 24 of the right-angle reflecting prism, parallel reflected lights 211 will be obtained due to the gathering function, and the parallel emergent lights 211 are injected into the optical waveguide and is propagated via the optical waveguide. Thus, an optical loss can be greatly reduced, thereby achieving high-efficient vertical optical coupling between the optical fibre and the optical waveguide.

According to at least one embodiment of the present disclosure, a method for manufacturing an optical coupling unit is provided. As shown in FIG. 10, the method includes the steps as follows.

1001: A reflecting surface of a right-angle reflecting prism is provided with a curve reflecting surface.

In an example embodiment, the right-angle reflecting prism may be made by adopting an optical polishing technology, and a locating guide pin hole is provided on the right-angle reflecting prism, so that a diameter and position of the locating guide pin hole is matched with a diameter and position of a locating guide pin hole in an mobile optical fibre connector.

The reflecting surface of the right-angle reflecting prism is provided with the curve reflecting surface, so that a central position and interval of the provided curve reflecting surface correspond to a central position and interval of an optical fibre coupling tube in the mobile optical fibre connector to be fixed to the right-angle reflecting prism.

A curvature and surface type of the curve reflecting surface are determined so as to determine a curve reflecting surface structure.

In an example embodiment, the curvature of the curve reflecting surface may be designed according to a value of an aperture parameter of the mobile optical fibre connector and a value of an aperture parameter of an optical waveguide, and specifically, the curve surface has a gathering function for light beams according to a principle of optical reflection. Thus, the curvature of the reflecting surface of the right-angle reflecting prism is necessary to be designed to ensure that after rays incident to the right-angle reflecting prism from an optical fibre at a maximum angle are gathered by the curve reflecting surface, an angle of reflection into the optical waveguide is smaller than an angle corresponding to a value of an aperture parameter of the optical waveguide, that is, there is no loss of light energy. The surface type of the curve reflecting surface optionally includes, but not limited to, a circular arc surface, a paraboloid and the like.

According to the designed curve structure, the reflecting surface is processed on the right-angle reflecting prism by using an ultraviolet laser ablation process, a carbon dioxide laser hot-melting process, a mechanical grinding process or an ultrasonic grinding process.

Wherein, the curve reflecting surface may be coated with a film in a vacuum manner to obtain a total reflection curve surface; and specifically, the curve reflecting surface may be coated with a gold thin film, a silver thin film or other metal thin films, or can be coated with other medium thin films.

Step 1002: The right-angle reflecting prism is fixed to the surface of the mobile optical fibre connector, so that rays propagated by the optical fibre are all exactly incident on the curve reflecting surface of the right-angle reflecting prism to form an optical coupling device.

In an example embodiment, locating guide pin holes matched with the right-angle reflecting prism and the mobile optical fibre connector are connected via a locating guide pin. In addition, the right-angle reflecting prism is fixed to the surface of the mobile optical fibre connector via a ultraviolet glue; and specifically, the ultraviolet glue may be applied to a joint between the guide pin and the reflecting prism and a joint between the guide pin and the mobile optical fibre connector; or may be applied to an area, connected to the mobile optical fibre connector, at an edge of the prism.

Step 1003: A groove is provided on the optical waveguide.

In an example embodiment, the groove being provided on the optical waveguide includes that: a groove is provided at a position above a planar optical waveguide substrate in the optical waveguide by utilizing ultraviolet laser on the basis of a laser ablation technology. The size of the groove is greater than or equal to the size of the right-angle reflecting prism. That is, the entire right-angle reflecting prism can be put into the groove.

Step 1004: The optical coupling device formed in Step 1002 is inserted into the groove provided in Step 1003 and fixed.

Fixing may be performed in multiple modes, including, but not limited to, adhesion fixing via ultraviolet glue. By inserting and fixing the optical coupling device into the groove of the optical waveguide, optical vertical coupling can be achieved.

It is important to note that the sequence numbers of the above steps are merely intended to distinguish different steps and do not limit the sequence of the steps. When all steps are executed, there is not a strict sequence.

The above is merely example embodiments of the present disclosure, and is not intended to limit the protection scope of the present disclosure.

1. An optical coupling device, comprising: a right-angle reflecting prism and a mobile optical fibre connector, wherein
a reflecting surface of the right-angle reflecting prism is provided with a curve reflecting surface, the curve reflecting surface being used for gathering and reflecting rays propagated by an optical fibre; and
the mobile optical fibre connector is fixed to the right-angle reflecting prism, to make the rays propagated by the optical fibre being incident on the curve reflecting surface of the right-angle reflecting prism.

2. The optical coupling device as claimed in claim 1, wherein the mobile optical fibre connector is provided with an optical fibre coupling tube, and a central position and an interval of the curve reflecting surface are identical to a central position and an interval of the optical fibre coupling tube.

3. The optical coupling device as claimed in claim 2, wherein a curvature of the curve reflecting surface is designed according to a value of an aperture parameter of the optical fibre coupling tube, to make rays incident on the curve reflecting surface from the optical fibre at a maximum incident angle being gathered by the curve reflecting surface and then reflected in parallel.

4. The optical coupling device as claimed in claim 3, wherein when a type of the right-angle reflecting prism of the optical coupling device is a single-path reflecting prism, a double-path reflecting prism, a single-row multi-path reflecting prism or a double-row multi-path reflecting prism in sequence, a type of the mobile optical fibre connector used for fixing the right-angle reflecting prism is a single-row mobile optical fibre connector, a double-path mobile optical fibre connector, a single-row multi-path mobile optical fibre connector or a double-row multi-path mobile optical fibre connector in sequence.

5. The optical coupling device as claimed in claim 1, wherein a diameter and position of a locating guide pin hole of the right-angle reflecting prism correspond to a diameter and position of a locating guide pin hole of the mobile optical fibre connector.

6. The optical coupling device as claimed in claim 5, wherein the mobile optical fibre connector is connected to the right-angle reflecting prism via a locating guide pin, and the locating guide pin is connected to the locating guide pin hole in the right-angle reflecting prism and the locating guide pin hole in the mobile optical fibre connector respectively; and
the right-angle reflecting prism is fixed to a surface of the mobile optical fibre connector via ultraviolet glue, and the ultraviolet glue is applied to a joint between the locating guide pin and the right-angle reflecting prism, and a joint between the locating guide pin and the mobile optical fibre connector; or applied to an area, connected to the mobile optical fibre connector, at an edge of the right-angle reflecting prism.

7. An optical coupling unit, comprising an optical waveguide and the optical coupling device, wherein the optical coupling device is provided being vertically inserted into the optical waveguide, to make rays reflected by the curve reflecting surface on the right-angle reflecting prism in the optical coupling device being incident in the optical waveguide and propagated;
wherein optical coupling device, comprising: a right-angle reflecting prism and a mobile optical fibre connector, wherein
a reflecting surface of the right-angle reflecting prism is provided with a curve reflecting surface, the curve reflecting surface being used for gathering and reflecting rays propagated by an optical fibre; and
the mobile optical fibre connector is fixed to the right-angle reflecting prism, to make the rays propagated by the optical fibre being incident on the curve reflecting surface of the right-angle reflecting prism.

8. The optical coupling unit as claimed in claim 7, wherein the optical coupling device being vertically inserted into the optical waveguide comprises: a groove being provided at a position above a planar optical waveguide substrate in the optical waveguide, the right-angle reflecting prism in the optical coupling device being vertically inserted into the groove, and a size of the groove being greater than or equal to a size of the right-angle reflecting prism.

9. The optical coupling unit as claimed in claim 8, wherein when a type of the right-angle reflecting prism in the optical coupling device is a single-path reflecting prism, a double-path reflecting prism, a single-row multi-path reflecting prism or a double-row multi-path reflecting prism in sequence, a type of the optical waveguide is a single-path optical waveguide, a double-path optical waveguide, a single-row multi-path optical waveguide or a double-row multi-path optical waveguide in sequence.

10. The optical coupling unit as claimed in claim 7, wherein a curvature of the curve reflecting surface of the right-angle reflecting prism in the optical coupling device is designed according to a value of an aperture parameter of an optical fibre coupling tube and a value of an aperture parameter of the optical waveguide, to make rays incident on the curve reflecting surface from the optical fibre at a maximum incident angle being gathered by the curve reflecting surface, and an angle of the reflected ray being smaller than an angle corresponding to an value of an aperture of the optical waveguide.

11. The optical coupling unit as claimed in claim 7, wherein the mobile optical fibre connector is provided with an optical fibre coupling tube, and a central position and an interval of the curve reflecting surface are identical to a central position and an interval of the optical fibre coupling tube.

12. The optical coupling device as claimed in claim 11, wherein a curvature of the curve reflecting surface is designed according to a value of an aperture parameter of the optical fibre coupling tube, to make rays incident on the curve reflecting surface from the optical fibre at a maximum incident angle being gathered by the curve reflecting surface and then reflected in parallel.

13. The optical coupling device as claimed in claim 12, wherein when a type of the right-angle reflecting prism of the optical coupling device is a single-path reflecting prism, a double-path reflecting prism, a single-row multi-path reflecting prism or a double-row multi-path reflecting prism in sequence, a type of the mobile optical fibre connector used for fixing the right-angle reflecting prism is a single-row mobile optical fibre connector, a double-path mobile optical fibre connector, a single-row multi-path mobile optical fibre connector or a double-row multi-path mobile optical fibre connector in sequence.

14. The optical coupling device as claimed in claim 7, wherein a diameter and position of a locating guide pin hole of the right-angle reflecting prism correspond to a diameter and position of a locating guide pin hole of the mobile optical fibre connector.

15. The optical coupling device as claimed in claim 14, wherein the mobile optical fibre connector is connected to the right-angle reflecting prism via a locating guide pin, and the locating guide pin is connected to the locating guide pin hole in the right-angle reflecting prism and the locating guide pin hole in the mobile optical fibre connector respectively; and
the right-angle reflecting prism is fixed to a surface of the mobile optical fibre connector via ultraviolet glue, and the ultraviolet glue is applied to a joint between the locating guide pin and the right-angle reflecting prism, and a joint between the locating guide pin and the mobile optical fibre connector; or applied to an area, connected to the mobile optical fibre connector, at an edge of the right-angle reflecting prism.

16. The optical coupling unit as claimed in claim 11, wherein the optical coupling device being vertically inserted into the optical waveguide comprises: a groove being provided at a position above a planar optical waveguide substrate in the optical waveguide, the right-angle reflecting prism in the optical coupling device being vertically inserted into the groove, and a size of the groove being greater than or equal to a size of the right-angle reflecting prism.

17. The optical coupling unit as claimed in claim 12, wherein the optical coupling device being vertically inserted into the optical waveguide comprises: a groove being provided at a position above a planar optical waveguide substrate in the optical waveguide, the right-angle reflecting prism in the optical coupling device being vertically inserted into the groove, and a size of the groove being greater than or equal to a size of the right-angle reflecting prism.

18. The optical coupling unit as claimed in claim 13, wherein the optical coupling device being vertically inserted into the optical waveguide comprises: a groove being provided at a position above a planar optical waveguide substrate in the optical waveguide, the right-angle reflecting prism in the optical coupling device being vertically inserted into the groove, and a size of the groove being greater than or equal to a size of the right-angle reflecting prism.

19. The optical coupling unit as claimed in claim 8, wherein a curvature of the curve reflecting surface of the right-angle reflecting prism in the optical coupling device is designed according to a value of an aperture parameter of an optical fibre coupling tube and a value of an aperture parameter of the optical waveguide, to make rays incident on the curve reflecting surface from the optical fibre at a maximum incident angle being gathered by the curve reflecting surface, and an angle of the reflected ray being smaller than an angle corresponding to an value of an aperture of the optical waveguide.

20. The optical coupling unit as claimed in claim 9, wherein a curvature of the curve reflecting surface of the right-angle reflecting prism in the optical coupling device is designed according to a value of an aperture parameter of an optical fibre coupling tube and a value of an aperture parameter of the optical waveguide, to make rays incident on the curve reflecting surface from the optical fibre at a maximum incident angle being gathered by the curve reflecting surface, and an angle of the reflected ray being smaller than an angle corresponding to an value of an aperture of the optical waveguide.
